(19) United States
(12) Patent Application Publication
(10) Pub. No.: US 2016/0250808 A1
(43) Pub. Date: Sep. 1, 2016

(54) System and Method for Printing Three Dimensional Objects

(71) Applicant: Mitsubishi Electric Research Laboratories, Inc., Cambridge, MA (US)

(72) Inventors: John C. Barnwell, III, Leominster, MA (US); William S. Yerazunis, Acton, MA (US)

(21) Appl. No.: 14/631,940

(22) Filed: Feb. 26, 2015

(51) Int. Cl. B29C 67/00

(52) U.S. Cl. CPC B29C 67/0081; B33Y 10/00

(57) ABSTRACT

A method prints a three dimensional (3D) object using a 3D printer depositing a stack of layers of print material. Each layer is bonded to at least a portion of another layer in the stack forming the object. The method provides a support layer of material, covers at least a portion of the support layer with a non-sticking material having a property selected to reduce bonding of the print material to the non-sticking material and to the support layer and deposes a layer of the print material on the support layer including the portion of the support layer covered with the non-sticking material.

### FIELD OF THE INVENTION

This invention relates generally to printing three dimensional (3D) objects, and more particularly to printing a 3D object using a 3D printer depositing a stack of layers of print material.

### BACKGROUND OF THE INVENTION

Additive and subtractive manufacturing technologies enable computer designs, such as CAD files, to be made into 3D objects. 3D printing, also known as additive manufacturing, typically includes depositing, curing, fusing, or otherwise forming a material into sequential cross-sectional layers of the 3D object. For example, fused deposition modeling techniques include melting a filament of print material and extruding the print material out of a dispenser that is moved in the x-, y-, and z-axes relative to a print pad. The print material is generally deposited in layers in the x- and y-axes to form cross-sectional layers that are stacked along the z-axis to form the 3D object.

3D objects that do not have a planar down-facing surface typically must be supported in some or all areas below the 3D objects. In addition, some additive manufacturing techniques cannot print a 3D object directly onto the print pad because such direct contact between the printed object and the print pad can cause surface flaws on the contacting surface of the printed object or may cause difficulty in the separation of the printed object from the print pad.

Various conventional methods have been developed to provide a mechanical support for printing different parts of the object. For example, one method uses special material selected to be either very brittle when cooled to the room temperature or soluble in another liquid, see, e.g., U.S. 2013/0236706. However, those methods require an application of force to remove the support structure and/or a liquid bath necessitating protracted immersion and agitation of the printed object to adequately dissolve away the support material.

Another method reducing the interface between the printed object and the support structure to a set of fine points, thereby reducing the force necessary to break and to separate the support structure, see, e.g., U.S. 2013/0307193. However, the additional extrusion material must be sufficiently strong to support the printed object, which can create a situation where breaking away the support material may also break portions of the final printed part. This makes the removal of the support material difficult and may require skilled labor, which negates many of the advantages of 3D printing.

### SUMMARY OF THE INVENTION

Some embodiments of the invention are based on recognition that it is not necessary to cool the printing material completely to provide a structural support for the subsequent printed layers. Instead, it is sufficient to cool the material only below the glass transition temperature. When the heat from hot extruded print material is removed sufficiently fast, the material becomes structurally strong reducing the need for an additional support or at least without a need for prolonged additional support.

Usually, the structures supporting overhanging parts of the printed object provide both mechanical support for printing the print material and serve as a heat sink to cool the print material below the glass transition temperature Tg. In fact, the supporting structure is attached, i.e., bonded, to the printed material to provide multi-directional support preventing deformation of the print material in all directions and to facilitate the cooling.

Some embodiments are based on additional realization that when the print material is rapidly cooled, there is no need for mechanical support in all directions, but only into the direction of sagging, e.g., a direction of a force of gravity. Such a mechanical support can be provided without attaching the support structure to the printed object. It is sufficient that the supporting structure support the print material from beneath, and let the cooling print material constrain itself in the other directions.

These realizations allow using a non-sticking material between layers of the support structure and the layers of printed object. A support structure covered with non-sticking material can provide vertical mechanical support to the printed layers without being attached to the printed layers, and serves as a heat transfer medium for cooling of the hot print material, which in turn prevents structural deformations in other directions within a plane of the layer.

Accordingly, one embodiment of the invention discloses a method for printing a three dimensional (3D) object using a 3D printer depositing a stack of layers of print material, such that each layer is bonded to at least a portion of another layer in the stack forming the object. The method includes providing a support layer of material; covering at least a portion of the support layer with a non-sticking material having a property selected to reduce bonding of the print material to the non-sticking material and to the support layer; and depositing a layer of the print material on the support layer including the portion of the support layer covered with the non-sticking material.

Another embodiment discloses a three dimensional (3D) printer for 3D objects by depositing a stack of layers of print material, such that each layer is bonded to at least a portion of another layer in the stack forming the object. The printer includes an extrusion nozzle for dispersing print material; an applicator for depositing non-sticking material having a property selected to reduce bonding of the print material to the non-sticking material; and a processor for coordinating a movement of the extrusion nozzle and a movement of the applicator, such that a printing of an object includes printing at least a portion of a layer of the print material on at least a portion of a support layer covered with the non-sticking material.

### BRIEF DESCRIPTION OF THE FIGURES

FIGS. 1A and 1B are schematics of an exemplar operation of a three dimensional (3D) printer for printing 3D objects according to some embodiments of the invention;

FIG. 2 is a schematic of a printer according to another embodiment of the invention;

FIG. 3 is a block diagram of a method for printing 3D objects according to some embodiments of the invention;

FIG. 4 is an examples of an object having an overhanging portion and printed according to some embodiments of the invention; and

FIG. 5A is another example of an object printed according to some embodiments of the invention; and

FIG. 5B is a cross section through FIG. 5A.

### DETAILED DESCRIPTION OF THE PREFERRED EMBODIMENTS

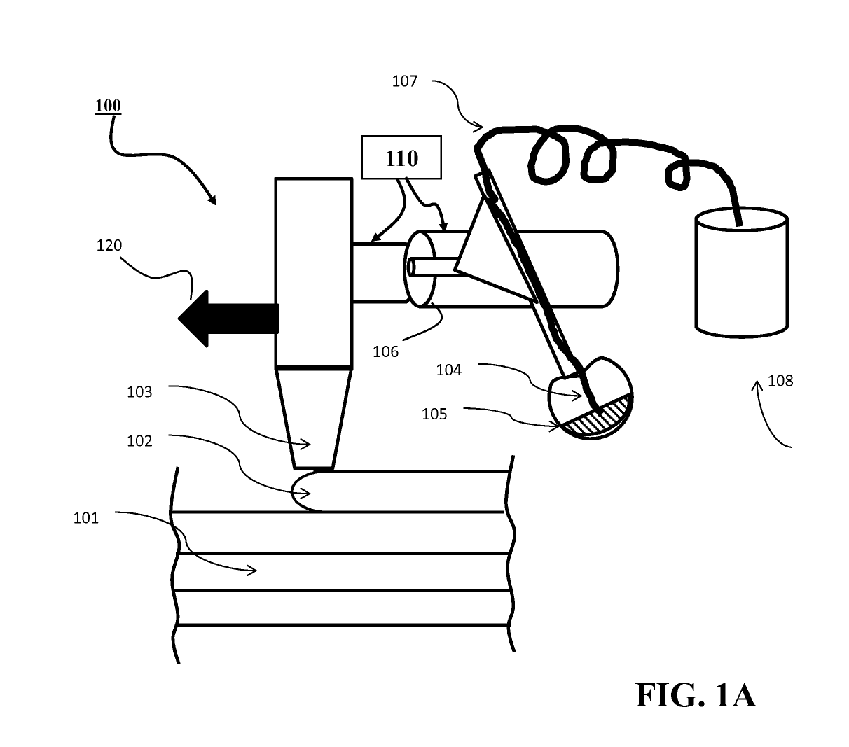

FIGS. 1A and 1B show a schematic of an exemplar operation of a printer for printing three dimensional (3D) objects by depositing a stack of layers 101 of print material according to some embodiments of the invention. The printer includes an extrusion nozzle 103 for dispersing melted print material 102. The melted print material 102 is dispersed into the surface of the previously deposited material 101, cools and bonds to the surface. As the nozzle 103 moves, another portion of the melted print material 102 is deposited forming another layer in the stack 101. Thus, each layer 101 is bonded to at least a portion of another layer in the stack forming the object.

The printer 100 also includes an applicator 104 for depositing non-sticking material 105 having a property selected to reduce bonding of the print material to the non-sticking material. For example, the non-sticking material can be oil. The printer 100 also includes a processor 110 for coordinating an operation of the extrusion nozzle and an operation of the applicator. In various embodiments, the processor controls the operations such that a printing of an object includes printing at least a portion of a layer of the print material on at least a portion of a support layer covered with the non-sticking material.

For example, at some point of time during the printing, as shown in FIG. 1A, the processor commands, to a motor 106, to place the applicator 104 in an elevated position so that the applicator 104 does not touch the deposited material forming layers 101 or 102 and does not deposit the non-sticking material 105. Concurrently, the processor 110 commands, e.g., to a separate dedicated motor (not shown), to move 120 the extrusion nozzle 103 into the proximity of the previously printed layers and to deposit the print material according to design of the object.

At a different point of the printing, as shown in FIG. 1B, to produce a separable joint in the layers, the processor commands the extrusion nozzle 103 to be withdrawn upward 125, removing the nozzle from the surface of the deposited material 101 and 102. The processor also commands the applicator to apply the non-sticking material 105 to at least on at least a portion of a layer 102. For example, the processor can command the motor 106 to place 130 the applicator 104 in contact with the deposited material 101 and 102, and motion of the assembly of nozzle 103, motor 106, and applicator 104 deposit a thin film 109 of non-sticking material 105 onto the surface of the deposited material 101 and/or 102. In this example, the layer 102 is a support layer covered with the film 109 of non-sticking material for printing the subsequent layers without bonding those layers to the support layer 102

In some embodiments, at least two motors coordinate movements of the extrusion nozzle and the applicator, such that the extrusion nozzle and the applicator interchange their positions during the movements. In some embodiments, the upward movement 125 of the nozzle 103 is optional and can be omitted when the placement locations for the release agent 108 are pre-sorted so the nozzle 103 does not perform a contacting traversal of an already-coated area.

In one embodiment, the applicator 104 is a contacting applicator for applying the non-sticking material via a mechanical contact with at least a portion of the support layer. The contacting applicator can include a porous material such as foam rubber, cotton, wool, felt, or porous thermoset fiber, to provide both a reservoir for the release agent and a soft, compliant contacting surface. In this embodiment, an optional reservoir 108 can be added to supply the non-sticking material 105 to the applicator 104 via a channel 107, which can be a tube, a wick, or other means, whether pumped or allowed to flow by gravity or capillary action.

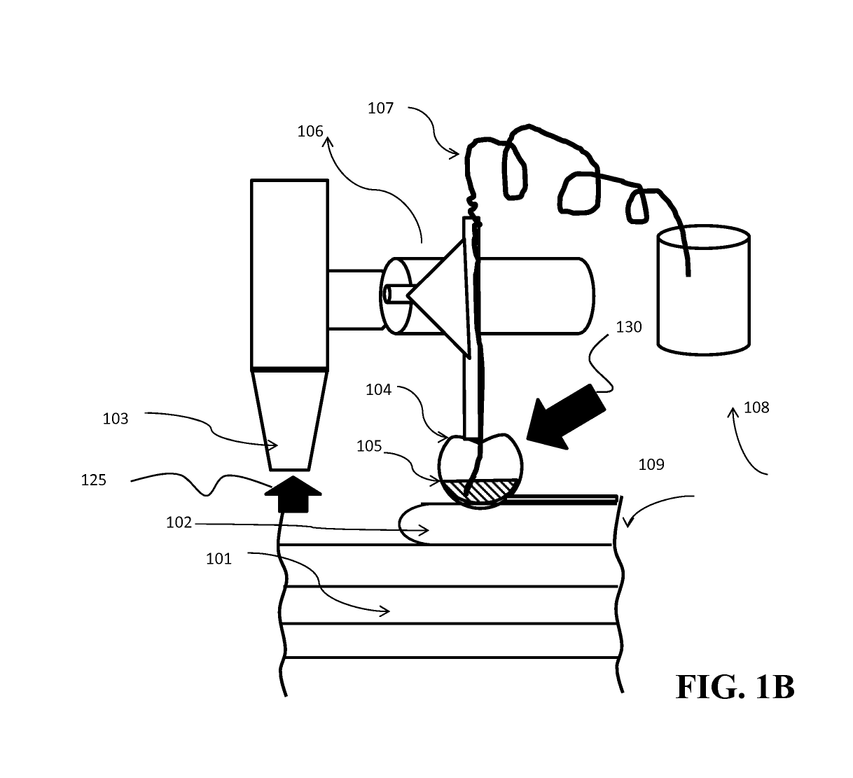

FIG. 2 shows a schematic of a printer according another embodiment of the invention. In this embodiment, the applicator 104 is a spraying applicator that includes a spray head 113 supplying the non-sticking material 114 under pressure. For example, in the embodiment of FIG. 2, the applicator 104 and associated equipment are replaced with a pressurized container 110 of the non-sticking material, connected via a channel 111 to nozzle 113 through valve 112. Because the non-sticking material in the container 110 is under pressure, the non-sticking material 110 flows through channel 111 and through the spray head 113, emitting the material as a spray 114, which is deposited as film 109 on support layer 102. Additionally or alternatively, one embodiment employs a non-pressurized container 110 and an additional pump to provide a pressurized spray of release agent material.

Some embodiments are based on a realization that when the print material is rapidly cooled, there is no need for mechanical support in all directions, but only into the direction of sagging, e.g., a direction of a force of gravity. Such a mechanical support can be provided without attaching the support structure to the printed object. It is sufficient that the supporting structure support the print material from beneath, and let the cooling print material constrain itself in the other directions.

This realization allows using a non-sticking material between layers of the support structure and the layers of printed object. A support structure covered with non-sticking material can provide vertical mechanical support to the printed layers without being attached to the printed layers, and serves as a heat transfer medium for cooling of the hot print material, which in turn prevents structural deformations in other directions within a plane of the layer.

In various embodiments, the non-sticking material is selected to have properties to reduce bonding of the print material to the non-sticking material and to the underlying support layer. For example, in some embodiments, the non-sticking material is liquid or powder preserving its state after forming the object. Examples of the non-sticking material include oil, such as cooking oil, mold release material, talcum powder and mica dust.

In some embodiments, the non-sticking material is selected to be easily removed from the final object, by, e.g., washing or evaporation. For example, in one embodiment, the volatility of non-sticking material is selected to be positive in a room temperature, e.g., the temperature around 20° C.

Additionally or alternatively, some embodiments heat to the printed object to a temperature sufficient to evaporate the non-sticking material without deforming the printed object. There are many non-sticking materials usable in the various embodiments of the invention. Some commonly available non-sticking materials include no-stick cooking spray, 3-in-1 oil that can be removed with soap and water, and Sprayon Dry Film Release Agent MR-311, which can be selected for its durability and lubricity.

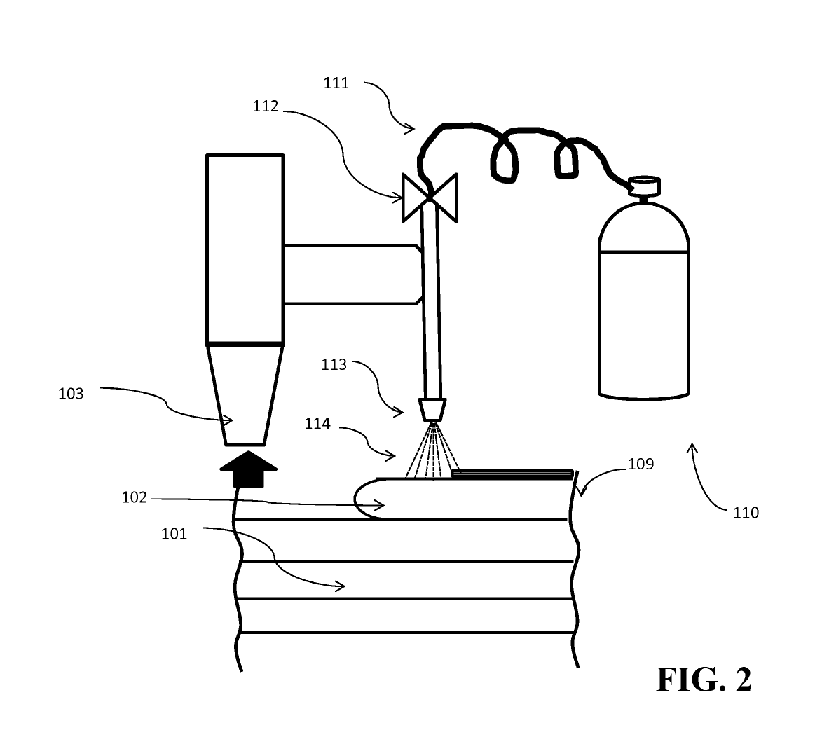

FIG. 3 shows a block diagram of a method for printing a three dimensional (3D) object using a 3D printer depositing a stack of layers of print material according to some embodiments of the invention. The method includes providing 310 a support layer of material, covering 320 at least a portion of the support layer with non-sticking material, and depositing 330 a layer of the print material on the support layer including the portion of the support layer covered with the non-sticking material.

After the layer of print material is deposited, the method can further dispense 340 a set of layers of the print material on the layer of the print material to form the object. In such a manner, each layer is bonded to at least a portion of another layer in the stack forming the object.

In some embodiments, the support layer is printed 360 with the print material and form a part of the object detached from another part of the object. In another embodiment, the support layer is also printed 360 but do not form the part of the object and subsequently removed or separated 350 from the layer of the print material to form the object. The non-sticking material prevents bonding of the print material to the support layer to facilitate such a separation. Additionally or alternatively, the support layer can be a surface of a structure manufactured by different means other than printing. For example, the support structure can be separately manufactured, e.g., using metal or other rigid material, and reused for printing multiple objects.

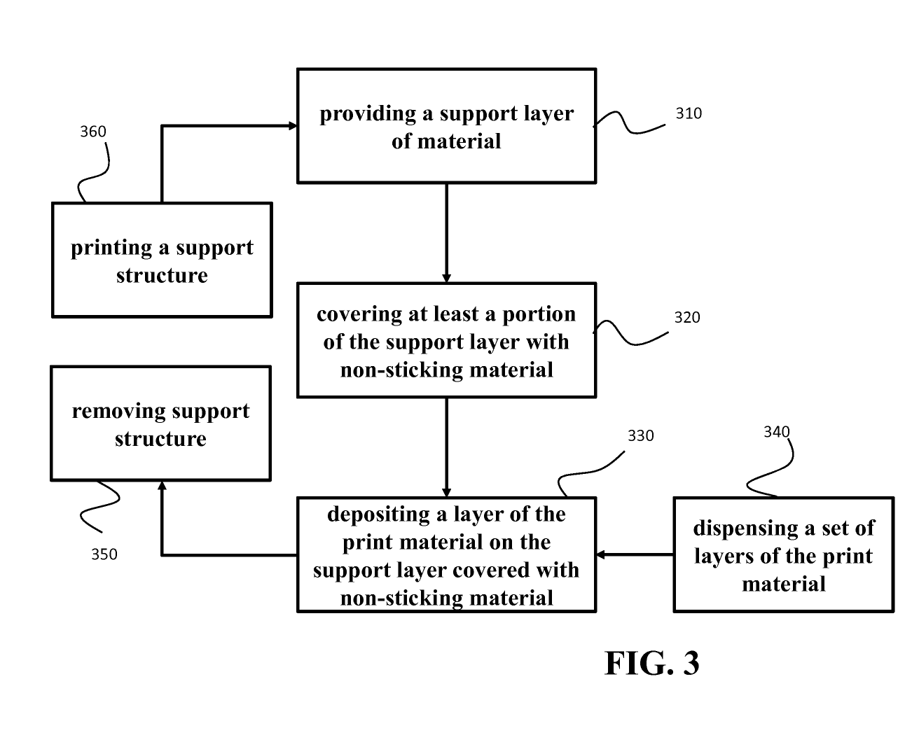

FIG. 4 shows an example of an object 410 printed according to some embodiments of the invention. The object 410 includes an overhanging portion 415 printed above the supporting structure 420. In this example supporting structure 420 is not part of the final shape of the object and is removed after the printing is complete. The non-sticking material is applied on surfaces 430 and/or 440 to facilitate the separation of the supporting structure 420 from the object 410.

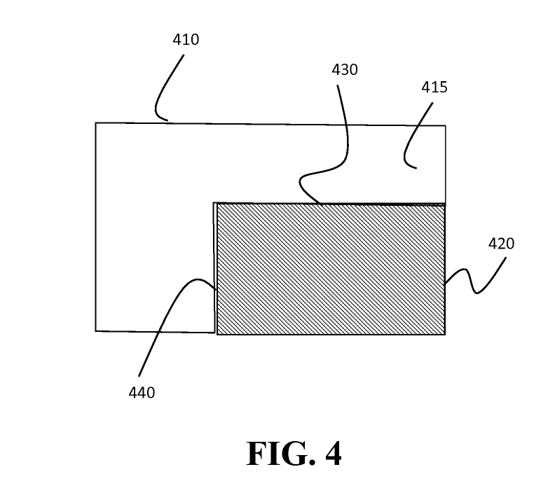

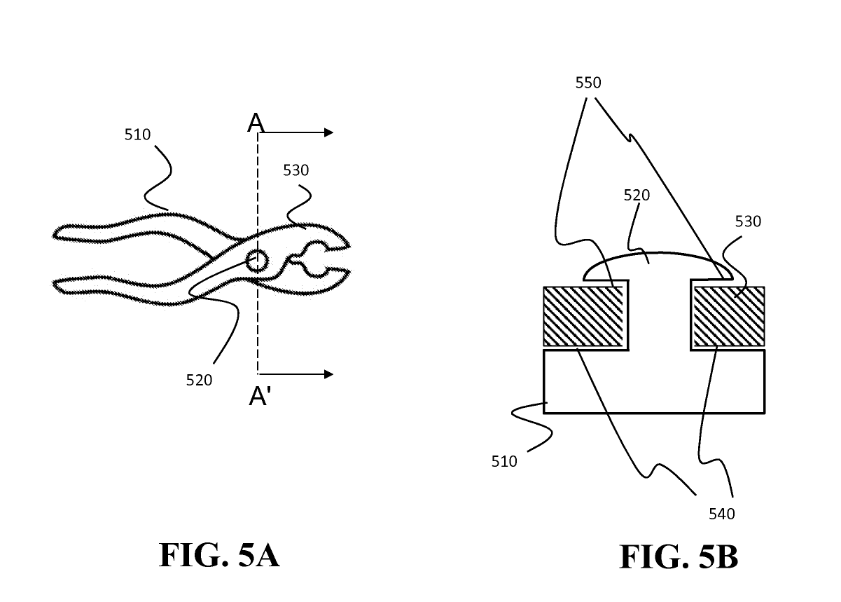

FIG. 5A shows another example of an object printed according to some embodiments of the invention. In this example, the object is a pair of pliers with lower part 510 and upper part 530. The lower part 510 includes the pivot rivet 520 to be printed as a contiguous part of the lower part 510. If such an object is printed without using principles employed by some embodiments of the invention, a large tolerance needs to be allocated between lower part 510 and upper part 530, to prevent handles to unmovably fuse together, and thus negating the usefulness of the result. In the prior art, making such a print would require a gap typically of 1 mm to be sufficient to prevent fusion, which would produce a very “sloppy” pair of pliers.

FIG. 5B shows a cross section through FIG. 5A and shows the application of the non-sticking material according to some embodiments. The non-sticking material is applied at two levels in the print—at junction surface 540, and again at junction surface 550. This allows the resulting print to be produced with nearly zero gap, giving a much more practical result.

Similarly, a spring clip with a zero unspring opening height can be fabricated as a single piece and used to hold cloth, paper, insulation, plastic film in the final assembly without requiring a second clamping element. Fabricating such a clip with the conventional printing is difficult due to the need of forming near zero gap for the desired rest position of the spring clip jaws.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for printing a three dimensional (3D) object using a 3D printer depositing a stack of layers of print material, such that each layer is bonded to at least a portion of another layer in the stack forming the object, comprising:
providing a support layer of material;
covering at least a portion of the support layer with a non-sticking material having a property selected to reduce bonding of the print material to the non-sticking material and to the support layer; and
depositing a layer of the print material on the support layer including the portion of the support layer covered with the non-sticking material.

2. The method of claim 1, wherein the support layer is printed with the print material and forms a part of the object.

3. The method of claim 1, further comprising:
separating the support layer from the layer of the print material to form the object.

4. The method of claim 3, wherein the providing comprises:
printing a support structure using the 3D printer, wherein a top surface of the support structure forms the support layer.

5. The method of claim 1, wherein the non-sticking material is liquid or powder preserving its state after forming the object.

6. The method of claim 5, wherein the non-sticking material includes oil.

7. The method of claim 1, wherein the non-sticking material is liquid having a volatility greater than a volatility of the print material.

8. The method of claim 7, wherein the volatility of non-sticking material is positive at a room temperature.

9. The method of claim of claim 7, further comprising:
heating the printed object to a temperature sufficient to evaporate the non-sticking material without deforming the object.

10. The method of claim 1, wherein the non-sticking material covers the entire support layer, such that the dispensing of the layer of the print material is unconstrained by other layers in all directions except a direction toward the support layer.

11. The method of claim 10, wherein the direction toward the support layer is a direction of a force of gravity.

12. The method of claim 1, further comprising:
dispensing a set of layers of the print material on the layer of the print material to form the object.

13. The method of claim 1, wherein the print material is deposited using an extrusion nozzle of the 3D printer, and wherein the non-sticking material is applied using an applicator including one or combination of a contacting applicator and a spraying applicator.

14. The method of claim 13, wherein the contacting applicator includes a porous material.

15. The method of claim 13, wherein the spraying applicator includes a spray head supplying the non-sticking material under pressure.

16. The method of claim 13, further comprising:
coordinating a movement of the extrusion nozzle and a movement of the applicator using a processor.

17. A three dimensional (3D) printer for 3D objects by depositing a stack of layers of print material, such that each layer is bonded to at least a portion of another layer in the stack forming the object, comprising:
an extrusion nozzle for dispersing print material;
an applicator for depositing non-sticking material having a property selected to reduce bonding of the print material to the non-sticking material; and
a processor for coordinating a movement of the extrusion nozzle and a movement of the applicator, such that a printing of an object includes printing at least a portion of a layer of the print material on at least a portion of a support layer covered with the non-sticking material.

18. The printer of claim 17, wherein the applicator comprises a porous material that applies the non-sticking material by contacting the support layer.

19. The printer of claim 17, wherein the applicator comprises a spraying applicator supplying the non-sticking material to the support layer under pressure.

20. The printer of claim 17, further comprising:
at least two motors for coordinating movements of the extrusion nozzle and the applicator, such that the extrusion nozzle and the applicator interchange their positions during the movements.
